(19) United States
(12) Patent Application Publication
(10) Pub. No.: US 2011/0091144 A1
(43) Pub. Date: Apr. 21, 2011

(54) ROLLER BEARING CAGE, ROLLER BEARING, AND METHOD FOR PRODUCING ROLLER BEARING CAGE

(75) Inventors: Shinji Oishi, Shizuoka (JP); Kouhei Kondou, Shizuoka (JP)

(73) Assignee: NTN Corporation, Osaka-shi,Osaka (JP)

(21) Appl. No.: 12/991,487

(22) PCT Filed: Apr. 10, 2009
(86) PCT No.: PCT/JP2009/057363

§ 371 Date: Nov. 8, 2010

(30) Foreign Application Priority Data
May 8, 2008 (JP) 2008-122057 2008

(51) Int. Cl. F16C 19/26; F16C 33/46; B21D 53/10

(52) U.S. Cl. 384/548; 384/572; 29/898.04

(57) ABSTRACT

In a step of forming a roller bearing cage (13) including a first roller stopper part (16a) provided on the radial inner side to prevent a roller from escaping to the radial inner side, and a second roller stopper part (17a) provided on the radial outer side to prevent the roller from escaping to the radial outer side, on wall surfaces (16b) and (17b) opposed to a pocket (20), respectively, each of the first and second roller stopper parts (16a) and (17a) is formed by a process only from the one radial side with a jig (60).

### FIELD OF THE INVENTION

The present invention relates to a roller bearing cage produced by a pressing process, a needle roller bearing having the roller bearing cage, and a method for producing the roller bearing cage.

### BACKGROUND ART

A cage & roller type needle robber bearing composed of rollers and a cage is employed as an idler bearing of a car transmission, and a con rod large end bearing of a motorbike engine in many cases. The inventor of the present invention has already proposed the following technique as the above bearing.

A roller bearing cage disclosed in Japanese Unexamined Patent Publication No. 2000-18258 (patent document 1) is a machined cage, in which an outer claw is formed in a center part of a column part by a machining process at the time of machining process to form a pocket. The outer claws prevent rollers from escaping to the cage outer diameter side. In addition, an inner claw is formed at each end of the column part by an ironing process. The inner claws prevent the rollers from escaping to the cage inner diameter side.

A roller bearing cage disclosed in Japanese Patent No. 3665653 (patent document 2) is a cage produced by a rolling process, in which a claw to prevent a roller from escaping from a pocket is formed after a step of punching out pockets in band steel. More specifically, the horizontally set band steel is subjected to an ironing process in a downward direction by an upper side clawing jig to form a roller stopper claw on the lower side of a column part. In addition, it is subjected to the ironing process in a upward direction by a lower clawing jig to form a roller stopper claw on the upper side of the column part. Then, the band steel is subjected to the rolling process to form an annular cage in which the roller stopper claw provided on the lower side of the column part is arranged on the outer diameter side.

### BACKGROUND ART DOCUMENT

Patent Document 1 Japanese Unexamined Patent Publication No. 2000-18258

Patent document 2 Japanese Patent No. 3665653

### SUMMARY OF THE INVENTION

### Problems to be Solved by the Invention

In recent years, a technique to produce a cage by the smaller number of processing steps is required due to a strong request for low cost. When the roller bearing cage is produced by the method disclosed in the Japanese Unexamined Patent Publication No. 2000-18258, the number of processing steps is to be improved because the step of providing the inner claw and the step of providing the outer claw are performed separately. In addition, when the roller bearing cage is produced by the method disclosed in the Japanese Patent No. 3665653, it is necessary to set the jig used for the step of providing the inner claw and the jig used for the step of providing the outer claw on both surface sides of the band steel before the rolling process, respectively, so that its process facility is to be improved.

The present invention was made in view of the above circumstances, and it is an object of the present invention to provide a roller bearing cage which can be produced with a simpler processing facility and by the smaller number of processing steps.

### Means for Solving the Problem

A roller bearing cage according to the present invention to attain the object includes a pair of annular ring parts, and a plurality of column parts to mutually connect the pair of ring parts, and has pockets to house rollers between the adjacent column parts, in which the column part includes a first roller stopper part arranged on the radial inner side to prevent the roller from escaping to the radial inner side, and a second roller stopper part arranged in the radial outer side to prevent the roller from escaping to the radial outer side which are provided on wall surfaces opposed to the pocket, and each of the first and second roller stopper parts is formed by a process only from one radial side.

According to the present invention, since each of the first and second roller stopper parts is formed by the process from the one radial side, the jib to form the first roller stopper part and the jig to form the second roller stopper part can be arranged on the same side with respect to the cage. Therefore, the processing facility of the roller stopper part can be simple. In addition, the jig to form the first roller stopper part and the jig to form the second roller stopper part can be integrated, so that the roller stopper parts on the inner diameter side and the outer diameter can be formed in the same step. Therefore, the number of processing steps can be reduced as compared with the conventional case.

The process to form each of the first and second roller stopper parts is not limited to the process from the radial outer side or inner side, but each of them is preferably formed by the process from the radial outer side. Thus, the first and the second roller stopper parts can be easily formed.

When each of the first and second roller stopper parts is formed by the process from the radial outer side, more specifically, the first roller stopper part is a burnished claw formed by burnishing the wall surface of the column part opposed to the pocket with a processing jig inserted from the radial outer side to the pocket. Thus, the burnished claw can prevent the roller from escaping to the radial inner side.

When each of the first and second roller stopper parts is formed by the process from the radial outer side, more specifically, the second roller stopper part is a caulked claw formed by caulking an outer diameter surface of the column part with a processing jig. Thus, the caulked claw can prevent the roller from escaping to the radial outer side.

While the shape of the column part is not limited to one embodiment, the column part preferably includes a column center part positioned on the relatively radial inner side in an axial center region, a pair of column end parts positioned on the relatively radial outer side in axial end regions, and a pair of column slope parts positioned between the column center part, and the pair of column end parts, respectively, and the first roller stopper part is provided in the column center part, and the second roller stopper part is provided in each of the pair of column end parts. Thus, the cage can be high in strength and light in weight.

More preferably, a thickness of each part of the column center part, the pair of column end parts, and the pair of column slope parts is smaller than a thickness of a boundary part adjacent to each part. Thus, the thickness of the boundary part is larger than that of the other parts, so that durability against the stress concentration can be improved. Therefore, a highly strong roller bearing cage can be provided.

In addition, when a contact area is increased between the roller and the column part, a contact surface pressure at a contact part can be reduced. As a result, the roller can be prevented from skewing, and the wall surface of the column part is prevented from being abraded and burned.

More preferably, a flange part extending from each of the pair of ring parts toward the radial inner side is further included, in which a thickness of the pair of ring parts, and the flange part is smaller than a thickness of a boundary part between the ring part and the flange part. Thus, the thickness of the boundary part is larger than those of the other parts, so that the highly strong roller bearing cage can be obtained.

In addition, a roller bearing according to the present invention includes the roller bearing cage according to the present invention, and a plurality of rollers housed in the pockets. According to the present invention, the roller bearing can be obtained by the smaller number of processing steps.

A method for producing a roller bearing cage according to the present invention is a method for producing a roller bearing cage including a pair of annular ring parts, a plurality of column parts to mutually connect the pair of ring parts, pockets to house rollers between the adjacent column parts, and first and second roller stopper parts provided on the radial inner side and the radial outer side, respectively, on wall surfaces of the column parts opposed to the pocket, to prevent the roller from escaping, and the method includes a step of forming the pair of ring parts, the plurality of column parts, and the pockets in a cylindrical member serving as a starting material, a step of forming the first roller stopper part by processing the cylindrical member only from one radial side, and a step of forming the second roller stopper part by processing the cylindrical member only from the one radial side.

According to the present invention, the production steps include the step of forming the first roller stopper part by processing the cylindrical member only from the one radial side, and the step of forming the first roller stopper part by processing the cylindrical member only from the one radial side, so that each of the first and second roller stopper parts can be formed by the process only from the one side, and the roller bearing can be obtained by the small number of processing steps as compared with the conventional case.

Preferably, the step of forming the first roller stopper part and the step of forming the second roller stopper part are performed at the same time. Thus, a time required for the process can be shortened, so that the roller bearing cage advantageous in cost can be produced in a short time.

### EFFECT OF THE INVENTION

Thus, regarding the roller bearing cage according to the present invention, each of the first roller stopper part positioned on the radial inner side and the second roller stopper part positioned on the radial outer side can be formed by the process only from the one radial side, so that the process facility of the roller stopper parts can be simple as compared with the conventional case. In addition, the roller bearing cage can be produced by the small number of processing steps as compared with the conventional case. Therefore, the roller bearing advantageous in cost can be provided.

### BRIEF DESCRIPTION OF DRAWINGS

FIG. 1 is a perspective view showing a roller bearing cage according to one embodiment of the present invention.

FIG. 2 is a perspective view showing a needle roller bearing employing the roller bearing cage in FIG. 1.

FIG. 3 is a perspective view showing a pocket structure of the roller bearing cage in FIG. 1.

FIG. 4 is a cross-sectional view of the roller bearing cage taken from an arrow IV in FIG. 3.

FIG. 5 is a variation of the roller bearing cage shown in FIG. 1, and a cross-sectional view corresponding to FIG. 4.

FIG. 6 is a flowchart showing main production steps of the roller bearing cage shown in FIG. 1.

FIG. 7 is a view showing a deep-drawing step.

FIG. 8 is a view showing a punching step.

FIG. 9 is a view showing a barring process.

FIG. 10 is a view showing a trimming process.

FIG. 11 is a view showing a state before a step of forming a column slope part and the like.

FIG. 12 is a view of an expansion pressing outer die taken from an axial direction.

FIG. 13 is a view showing a state in the middle of the expansion pressing step.

FIG. 14 is a view showing a state after the expansion pressing step.

FIG. 15 is a view showing a step of thickening process of a boundary part.

FIG. 16 is a perspective view showing a step of forming pockets.

FIG. 17 is a cross-sectional view of the step shown in FIG. 16.

FIG. 18 is a cross-sectional view showing a state taken along A-A and taken from an arrow direction in FIG. 17, and showing a state before a burnishing process.

FIG. 19 is a cross-sectional view showing a state taken along A-A and taken from the arrow direction in FIG. 17, and showing a state after a first roller stopper part has been formed by the burnishing process.

FIG. 20 is a cross-sectional view showing a state taken along B-B and taken from an arrow direction in FIG. 17, and showing a state after a second roller stopper part has been formed by a caulking process.

FIG. 21 is a perspective view showing a roller bearing cage according to another embodiment of the present invention.

FIG. 22 is a perspective view showing a needle roller bearing employing the roller bearing cage in FIG. 21.

FIG. 23 is a perspective view showing a pocket structure of the roller bearing cage in FIG. 21.

FIG. 24 is a view taken from an arrow XXIV in FIG. 23.

FIG. 25 is a variation of the roller bearing cage shown in FIG. 21, and corresponds to FIG. 24.

FIG. 26 is a view showing a preprocessing step.

FIG. 27 is a view of a necking inner die taken from an axial direction.

FIG. 28 is a view showing a post-processing step.

### EMBODIMENTS FOR CARRYING OUT THE INVENTION

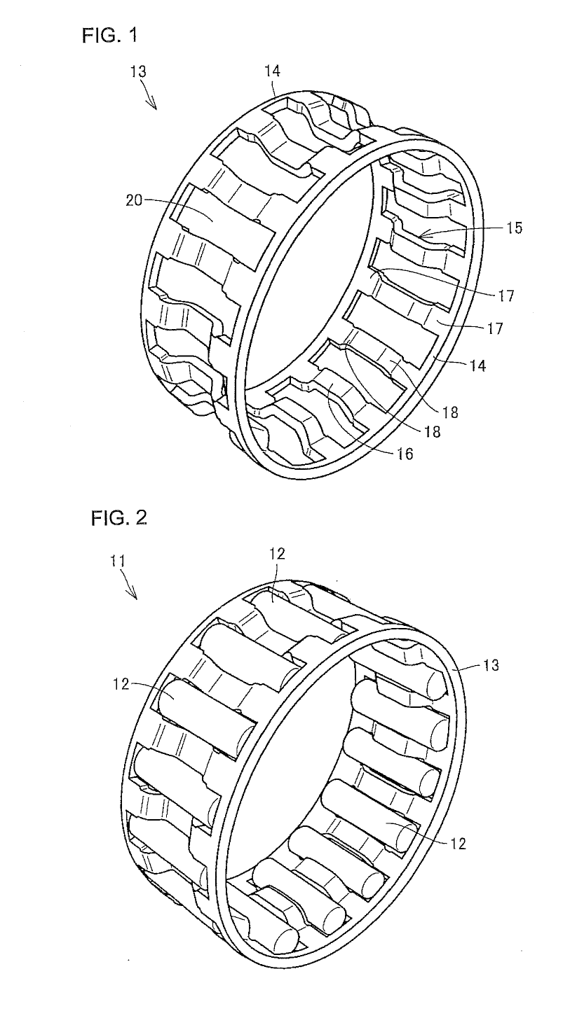

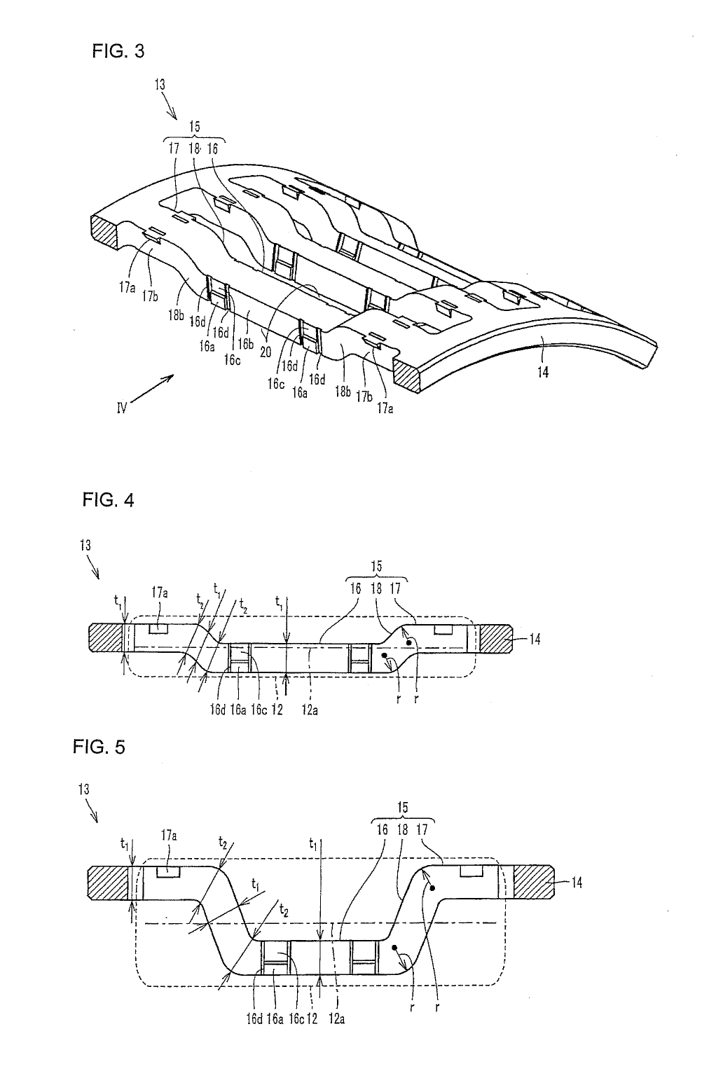

A description will be made of a needle roller bearing 11 and a roller bearing cage 13 (hereinafter, simply referred to as the “cage 13”) according to one embodiment of the present invention with reference to FIGS. 1 to 4. In addition, FIG. 1 is a perspective view of the cage 13, FIG. 2 is a perspective view of the needle roller bearing 11, FIG. 3 is a perspective view showing a shape of a column part 15 of the cage 13 and FIG. 4 is a view taken from a direction of an arrow IV in FIG. 3.

First, referring to FIG. 2, the needle roller bearing 11 includes a plurality of needle rollers 12, and the cage 13 to retain the plurality of needle rollers 12. Next, referring to FIG. 1, the cage 13 includes a pair of annular ring part 14, and the plurality of column parts 15 to mutually connect the pair of ring parts 14. In addition, a pocket 20 to hold the needle roller 12 is formed between the adjacent column parts 15.

In addition, the “annular ring part” in this specification means only an integral ring part continued in a circumferential direction. That is, it is to be noted that a ring part which made from a metal plate and both ends of the metal plate are connected by welding and the like is not included.

The column part 15 includes a column center part 16 positioned on the relatively radial inner side in its axial center region, a pair of column end parts positioned relatively radial outer side in its axial end regions, and a pair of column slope parts 18 positioned between the column center part 16 and the pair of column end parts 17.

Next, referring to FIGS. 3 and 4, a rotation of the needle roller 12 is guided by wall surfaces 16b, 17b, and 18b of the column part 15 opposed to the pocket 20. Among them, the wall surface 16b of the column center part 16 has a first roller stopper part 16a to prevent the needle roller 12 from escaping, a non-contact part 16c, and an oil groove 16d. In addition, the wall surface 17b of the column end part 17 has a second roller stopper part 17a to prevent the needle roller 12 from escaping.

The first roller stopper parts 16a are provided at two positions of the column center part 16. More specifically, they are located on the radial inner side of the wall surface 16b of the column center part 16 opposed to the pocket 20. Thus, the needle roller 12 is prevented from escaping to the radial inner side.

The second roller stopper parts 17a are provided in the pair of column end parts 17 respectively. More specifically, they are located on the radial outer side of the wall surfaces 17b of the column end parts 17 opposed to the pocket 20. Thus, the needle roller 12 is prevented from escaping to the radial outer side.

The first and second roller stopper parts 16a and 17a can effectively prevent the needle roller 12 from escaping from the cage 13 while sufficiently ensuring an allowance amount of the needle roller 12 even when the needle roller 12 has a small diameter.

The wall surface 16b is positioned between the two first roller stopper parts 16a in the column center part 16. The wall surface 17b is adjacent to the second roller stopper part 17a in the column end part 17. The wall surface 18b is positioned between the first roller stopper part 16a and the wall surface 17b, in the column slope part 18. In addition, the wall surfaces 16b, 17b, and 18b constitute a planar surface having the same height. In addition, the wall surfaces 16b, 17b, and 18b which are opposed across the pocket 20 are parallel to each other. Thus, the needle roller 12 can be rotated in a stable manner.

The non-contact part 16c is provided in a region radially adjacent to each of the first and second roller stopper parts 16a. Since the non-contact part 16c is recessed as compared with the wall surfaces 16b, 17b, and 18b, it is opposed to the needle roller 12 with a predetermined space. The non-contact part 16c is inclined in such a manner that the predetermined space increases with increasing distance from the first roller stopper part 16a in the radial direction.

More specifically, the non-contact part 16c is provided in the region positioned on the radially outer side of the first roller stopper part 16a, and inclined in such a manner that the space from the needle roller 12 increases toward the radial outer side.

Thus, an amount of a lubricant oil flowing into the first roller stopper part 16a increases. As a result, an oil film on the first roller stopper part 16a can be prevented from being cut.

The oil groove 16d is provided on each axial side of the first roller stopper part 16a. The oil groove 16d extends in the radial direction, and further recessed as compared with the non-contact part 16c. Thus, an amount of the lubricant oil flowing in the radial direction can increase, so that an oil passing property in the radial direction can be improved in the cage 13. The improvement in oil passing property contributes to removal of abrasion powder and prevention of a temperature rise of the needle roller bearing 11.

In addition, the lubricant oil flowing out of the oil groove 16d can be supplied to the adjacent first roller stopper part 16a, and the wall surfaces 16b, 17b, and 18b, so that the oil film on the first roller stopper part 16a and the like can be prevented from being cut.

Regarding the above column part 15, thicknesses t1 of the column center part 16, the column end part 17, and the column slope part 18 (hereinafter, collectively referred to as the “linear part”) are set to be substantially equal. Meanwhile, thicknesses t2 of a boundary part between the column center part 16 and the column slope part 18, and a boundary part between the column end part 17 and the column slope part 18 (hereinafter, collectively referred to as the “boundary part”) are larger than the thickness t1 of the linear part (t1<t2). Thus, strength of the boundary part is relatively improved. As a result, even when a stress concentrates on the boundary part at the time of the bearing rotation, durability of the cage 13 can be improved. In addition, the thickness means a thickness dimension between an inner diameter surface and an outer diameter surface.

In addition, the thickness t1 of the linear part and a curvature radius r of the boundary part satisfies a relationship such that r<t1. By setting the curvature radius r of the boundary part to be smaller, an axial length of the linear part adjacent to the boundary part can be long, that is, a surface area of the linear part can be large. As a result, a contact surface pressure can be reduced at the time of the bearing rotation.

More specifically, when the cage 13 is an outer diameter side guide (housing guide), an outer diameter surface of the column end part 17 and a housing (not shown) are in contact with each other. Thus, by setting at least the curvature radius r of the boundary part between the column end part 17 and the column slope part 18 to be within the above range, a contact surface pressure between the outer diameter surface of the column end part 17 and the housing can be reduced.

In addition, a surface roughness Ra of the outer diameter surface of the ring part 14 and the column end part 17 is set to be 0.05 μm to 0.3 μm. Thus, abrasion can be prevented from being generated due to the contact between the outer diameter surface of the ring part 14 and the column end part 17, and the housing. In addition, the “surface roughness Ra” means arithmetic mean roughness.

Meanwhile, when the cage 13 is an inner diameter side guide (rotation shaft guide), an inner diameter surface of the column center part 16 and the rotation shaft (not shown) are in contact with each other. Thus, by setting at least the curvature radius r of the boundary part between the column center part 16 and the column slope part 18 to be within the above range, a contact surface pressure between the inner diameter surface of the column center part 16 and the rotation shaft can be reduced. In addition, in this case, a surface roughness Ra of the inner diameter surface of the column center part 16 is set to be 0.05 μm to 0.3 μm.

In addition, the boundary part has a R part formed on each of the projection side (to which a tensile stress is applied at the time of bending process) and the recession side (to which a compression stress is applied at the time of bending process). At this time, the curvature radius on the projection side is always larger than the curvature radius on the recession side. Here, the “curvature r of the boundary part” in this specification means the curvature radius on the projection side. In addition, the “thickness t2 of the boundary part” means a length of a line connecting a center part of the projection side and a center part of the recession side.

In addition, an outer diameter surface of the column center part 16 is positioned on the radial outer side with respect to an inner diameter surface of the column end part 17. Thus, a pitch circle 12a of the needle roller 12 is positioned on the radial inner side with respect to the outer diameter surface of the column center part 16 and on the radial outer side with respect to an inner diameter surface of the column end part 17. Thus, the needle roller 12 is in contact with the wall surfaces 16b, 17b, and 18b. Thus, since the contact area between the needle roller 12 and the wall surfaces 16b, 17b, and 18b is large, the needle roller 12 can be effectively prevented from skewing.

However, the positional relationship between the column center part 16 and the column end part 17 is not limited to the above. A variation of the cage 13 will be described with reference to FIG. 5. In addition, FIG. 5 is a view showing the variation of the cage 13, and corresponds to FIG. 4. In addition, since a shape and a function of each component are the same, the same component has the same reference numeral and its description is omitted.

Referring to FIG. 5, the outer diameter surface of the column center part 16 is positioned on the radial inner side with respect to the inner diameter surface of the column end part 17. Thus, the pitch circle 12a of the needle roller 12 is positioned on the radial outer side with respect to the outer diameter surface of the column center part 16 and on the radial inner side with respect to the inner diameter surface of the column end part 17. In this case, the needle roller 12 is guided only by the wall surface 18b of the column slope part 18. In this configuration, since the first roller stopper part 16a and the second roller stopper part 17a are arranged to be apart from each other in the radial direction, the needle roller 12 can be appropriately prevented from escaping.

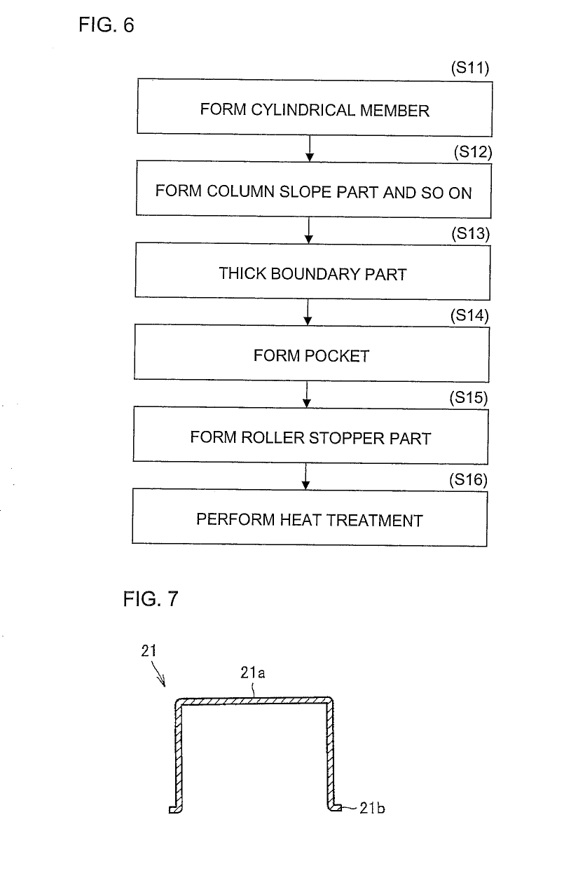

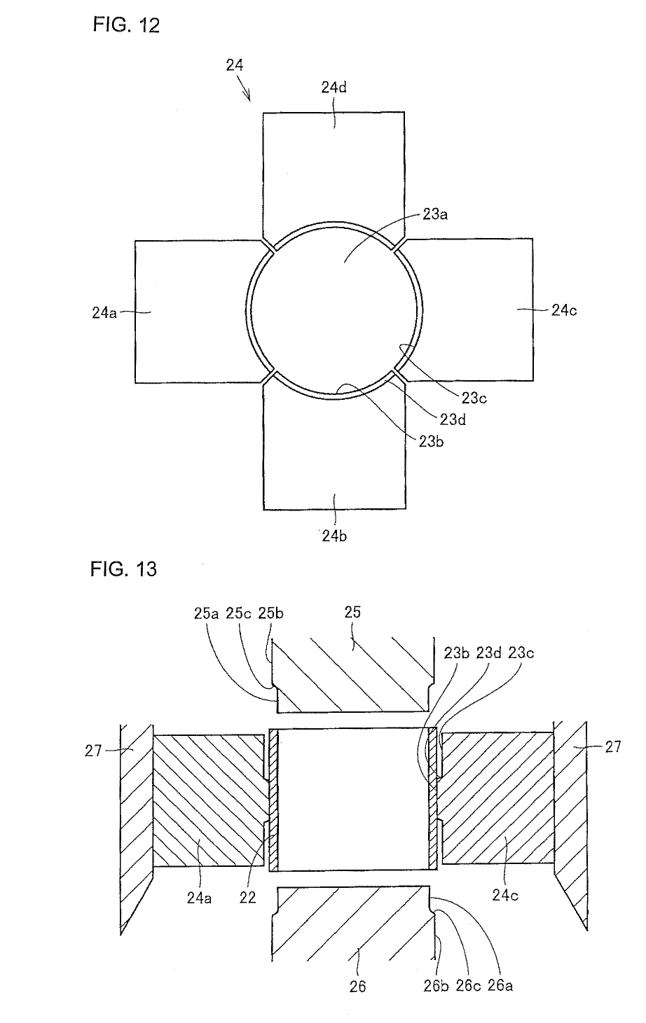

Next, a method for producing the cage 13 will be described with reference to FIGS. 6 to 20. In addition, FIG. 6 is a flowchart showing main production steps of the cage 13 which are composed of first to sixth steps.

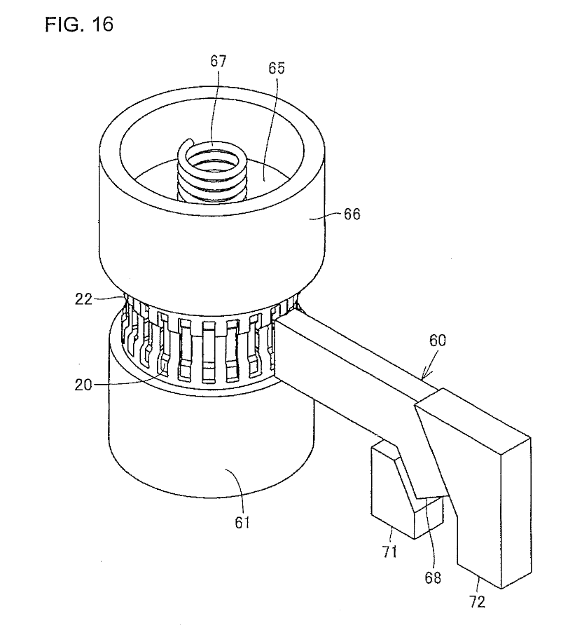

In addition, FIGS. 7 to 10 are explanatory views to show a detail of the first step, FIGS. 11 to 14 are explanatory views to show a detail of the second step, FIG. 15 is an explanatory view to show a detail of the third step, and FIGS. 16 to 20 are explanatory views to show a detail of the fifth step.

First, as a starting material of the cage 13, a steel (carbon steel) plate containing 0.15% to 1.1% by weight of carbon is used. More specifically, the material includes SCM415 and S50C containing 0.15% to 0.5% by weight of carbon, and SAE1070 and SK5 containing 0.5% to 1.1% by weight of carbon. This is because when carbon steel containing less than 0.15% by weight of carbon is used, a carburized hard layer is not likely to be formed by a quenching treatment, so that a carbonitriding treatment is needed to obtain hardness required for the cage 13. In addition, since the carbonitriding treatment is high in cost of facility as compared with the quenching treatments which will be described below, and as a result, the needle roller bearing 11 is high in production cost. In addition, when carbon steel containing less than 0.15% by weight of carbon is used, a preferable carburized hard layer cannot be provided even by the carbonitriding treatment in some cases, so that surface-starting type flaking could be generated in an early stage. Meanwhile, carbon steel containing more than 1.1% by weight of carbon is considerably low in processability.

In addition, the starting material of the cage 13 may also be SPC containing 0.15% or less by weight of carbon. In this case, burnishing and caulking processes which will be described below can be easily performed.

In the step S11 shown in FIG. 6, a cylindrical member 22 is formed from a flat steel plate serving as the above starting material. More specifically, referring to FIG. 7, a cup-shaped member 21 is obtained from the steel plate by a deep-drawing process. At this time, a bottom wall 21a is formed at one axial side end (upper side in FIG. 7) and an outward flange part 21b is formed at the other axial end (lower side in FIG. 7) in the cup-shape member 21. In addition, at this time, the outer diameter surface or an inner diameter surface of the cup-shaped member 21 is processed to have a surface roughness Ra of 0.05 um to 0.3 μm by an ironing process.

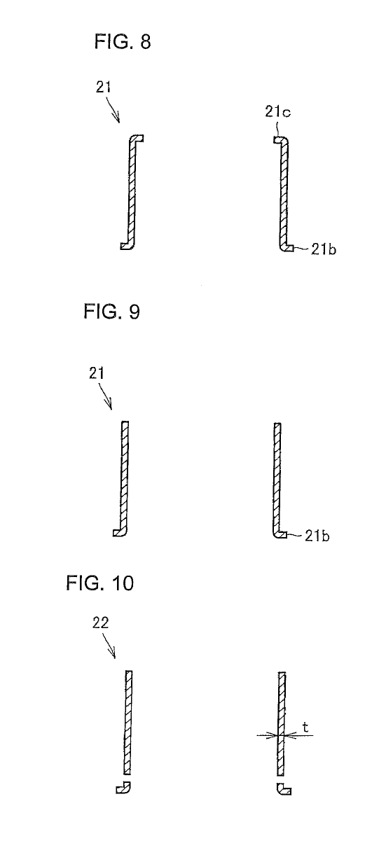

Then, referring to FIG. 8, the bottom wall 21a of the cup-shaped member 21 is removed by a punching process. However, the bottom wall 21a cannot be completely removed by the punching process, so that an inward flange part 21c is formed at the one axial side end of the cup-shaped member 21.

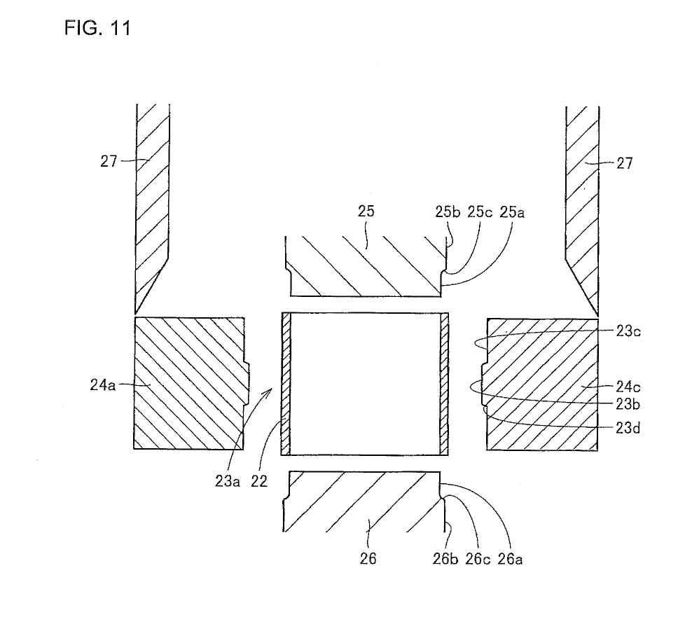

Then, referring to FIG. 9, the inward flange part 21c is made straight in the axial direction by a burring process. Furthermore, referring to FIG. 10, the outward flange part 21b is removed by trimming the other axial side end of the cup-shaped member 21 by a trimming process.

In this way, the cylindrical member 22 shown in FIG. 10 is formed. An outer diameter dimension of the cylindrical member 22 obtained through the above steps coincides with an outer diameter dimension of the column center part 16. In addition, a thickness of the cylindrical member 22 obtained through the above steps is defined as a thickness t.

Then, in the second step S12 shown in FIG. 6, the cylindrical member 22 is deformed in the radial direction to form the column center part 16, the pair of column end parts 17, and the pair of column slope parts 18. According to this embodiment, a diameter of each axial end is expanded (expansion pressing) with an expansion pressing outer die 24 (hereinafter, simply referred to as the “outer die 24”) to hold an outer diameter surface of the cylindrical member 22, and with a pair of expansion pressing inner dies 25 and 26 (hereinafter, simply referred to as the “inner dies 25 and 26) to hold an inner diameter surface of the cylindrical member 22.

Referring to FIGS. 11 to 14, the outer die 24 has a cylindrical space 23a to receive the cylindrical member 22 therein. A surface of the outer die 24 opposed to the cylindrical space 23a is composed of a small diameter part 23b corresponding to the outer diameter dimension of the column center part 16, a large diameter part 23c corresponding to an outer diameter dimension of the column end part 17, and a slope part 23d provided between the small diameter part 23b and the large diameter part 23c so as to correspond to a sloped angle of the column slope part 18.

The first inner die 25 is a column-shaped member which is inserted from one axial side end (upper side in FIG. 11) of the hollow cylindrical member 22. The first inner die 25 is composed of a small diameter part 25a corresponding to an inner diameter dimension of the column center part 16, a large diameter part 25b corresponding to an inner diameter dimension of the column end part 17, and a slope part 25c provided between the small diameter part 25a and the large diameter part 25b so as to correspond to the sloped angle of the column slope part 18. The second inner die 26 has the same configuration and it is inserted from the other axial side end (lower side in FIG. 11) of the cylindrical member 22.

The outer die 24 is composed of first to fourth split outer dies 24a, 24b, 24c, and 24d radially split at intervals of 90°, for example. Each of the first to fourth split outer dies 24a to 24d can be moved in the radial direction of the cylindrical member 22 by a moving jig 27. In addition, each of the first and second inner dies 25 and 26 can be moved in the axial direction of the cylindrical member 22.

Referring to FIG. 11, when the first to fourth split outer dies 24a to 24d are moved backward to the radial outer side, and the first and second inner dies 25 and 26 are moved backward in the axial direction so as to be away from each other, the cylindrical member 22 can be taken in and out from the cylindrical space 23a. That is, the “moving backward” means moving in a direction away from the cylindrical member 22.

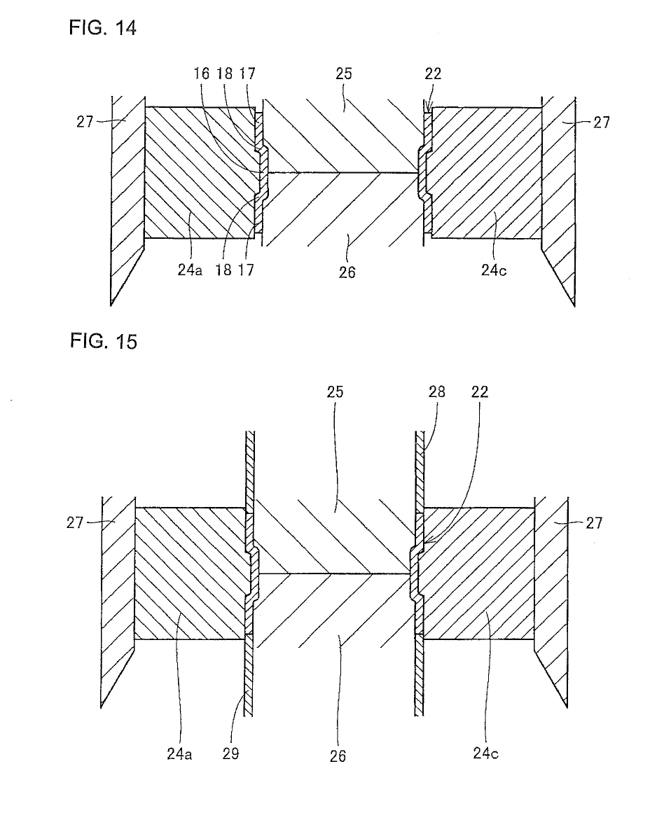

Next, referring to FIG. 13, when the first to fourth split outer dies 24a to 24d are moved forward to the radial inner side, the small diameter part 23d holds the outer diameter surface of the cylindrical member 22. Furthermore, referring to FIG. 14, when the first and second inner dies 25 and 26 are moved forward in the axial direction so as to come close to each other, axial both ends of the cylindrical member 22 are expanded toward the radial outer side by the slope parts 25c and 26c and then by the large diameter parts 25b and 26b. That is, the “moving forward” means moving in a direction close to the cylindrical member 22.

Thus, the column center part 16, the pair of column end parts 17, and the pair of column slope parts 18 are formed. In addition, since the cylindrical member 22 is expanded by the expansion pressing, the thickness t1 of the pair of column end parts 17 and the pair of column slope parts 18 is smaller than the thickness t of the cylindrical member 22 (t1<t) after the second step. In addition, since the cylindrical member 22 is radially narrowed by the outer die 24 and the inner dies 25 and 26, the thickness t1 of the column center part 16 is smaller than the thickness t of the cylindrical member 22 after the second step (t1<t). In addition, the thickness t1 inclusively represents the thicknesses of the column center part 16, the pair of column end parts 17, and the pair of column slope parts 18, so that this does not mean that the thicknesses of these parts 16, 17, and 18 are the same.

Then, in the third step S13 shown in FIG. 6, the boundary part is thickened by a thickening process.

Referring to FIG. 15, a pair of cylindrical compressing jigs 28 and 29 is used in the thickening process. More specifically, under the condition that the cylindrical member 22 is held by the outer die 24 and the inner dies 25 and 26 (under the condition that the expansion pressing is performed), axial both end faces of the cylindrical member 22 are compressed from both sides by the pair of compressing jigs 28 and 29.

At this time, since the inner and outer diameter surfaces of the linear part are held by the outer die 24 and the inner dies 25 and 26, their thicknesses do not change. Meanwhile, small gaps are formed between the boundary parts, and the outer die 24 and the inner dies 25 and 26. Thus, the axial dimension of the cylindrical member 22 is decreased, and only the boundary part is thickened. The thickness t2 of the boundary part after the third step is larger than the thickness t of the cylindrical member 22 provided in the first step (t1<t<t2). Thus, instead of increasing the thickness of the whole column part 15 to improve the strength, the linear part is thinned and the boundary part on which the stress concentrates is selectively thickened to improve the strength. Therefore, the cage 13 can be light in weight. In addition, at the same time, the curvature radius r of the boundary part also becomes smaller than the thickness t1 of the linear part.

Then, in the fourth step S14 shown in FIG. 6, the pocket 20 and the oil groove 16d are formed in the cylindrical member 22. More specifically, the plurality of pockets 20 and oil grooves 16d are formed in the circumferential surface of the cylindrical member 22 by a punching process using a punch and a die. The punch is composed of a rectangular portion corresponding to the pocket 20 and a projecting portion projecting from the rectangular portion in a circumferential direction to correspond to the oil groove 16d. Thus, by performing the process to punch out the pocket in the cylindrical member 22, the wall surfaces 16b, 17b, and 18b opposed to each other across the pocket 20 can be parallel to each other.

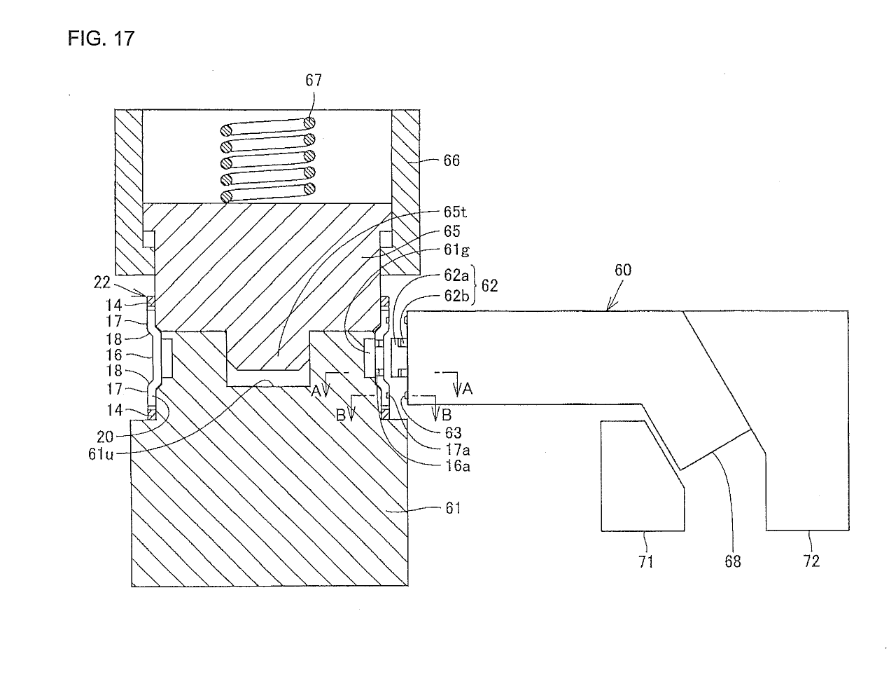

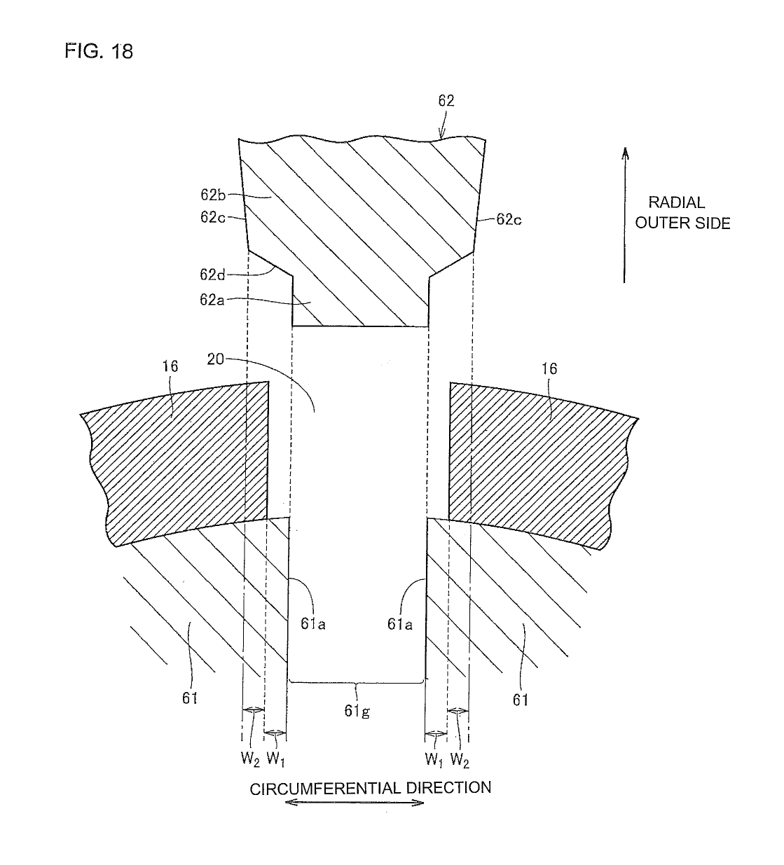

Then, in the fifth step shown in FIG. 6, the first roller stopper part 16a and the second roller stopper part 17a are formed in the column part 15 of the cylindrical member 22. FIG. 16 is a perspective view showing a situation when the roller stopper parts 16a and 17a are formed by jigs 60 to 72. FIG. 17 is a partial cross⁻sectional view showing cross-sections of the cylindrical member 22 and a process table 61 and the like. The cylindrical process table 61 is concentrically inserted to the cylindrical member 22 having the pockets 20, from one axial direction. The process table 61, as shown in FIG. 17, is in contact with the inner diameter surface of the column center part 16, the inner diameter surface of one column slope part 18, and an inner diameter surface of the one column end part 17, and an inner diameter surface of the one ring part 14 so as to support them. In addition, a cylindrical process table 65 is concentrically inserted into the cylindrical member 22 from the other axial direction. As shown in FIG. 17, the process table 65 is forced to go forward from a cylindrical process table base 66 by a spring 67. Thus, a tip end projection 65t of the process table 65 is inserted into the cylindrical member 22 and engages with a tip end recession 61u of the process table 61, and the process table 65 is in contact with an inner diameter surface of the other column slope part 18, and an inner diameter surface of the other column end part 17, and an inner diameter surface of the other ring part 14 so as to support them.

The jig 60 is arranged on the radial outer side of the process table 61 and the process table 65, and radially extends such that its tip end is opposed to the process table 61. A burnishing jig 62 and a caulking jig 63 are provided at the tip end of the jig 60. Meanwhile, a base end 68 of the jig 60 engages with an actuator 71 and an actuator 72 which moves the jig 60 back and forth with respect to the process table 61.

As shown in FIG. 17, the two burnishing jigs 62 are provided at the tip end of the jig 60 axially spaced to each other. This space is a little smaller than the axial dimension of the column center part 16, and the burnishing jigs 62 form the first roller stopper parts 16a at both ends of the column center part 16 by a process only from the one radial side.

In addition, as shown in FIG. 17, the two caulking jigs 63 are also provided at the tip end of the jig 60 so as to be axially spaced to each other. This space is equal to a distance between the pair of column end parts 17 and 17, and the caulking jigs 63 form the second roller stopper parts 17a in the pair of column end parts 17 and 17, respectively only by a process from the one radial direction.

FIG. 18 is a cross-sectional view showing a state taken along A-A and taken from an arrow direction shown in FIG. 17, and schematically shows the burnishing process by the burnishing jig 62. As shown in FIG. 18, the process table 61 is provided with guide surfaces 61a to guide the burnishing jig 62, and the guide surfaces 61a opposed in parallel form a guide groove 61g corresponding to the pocket 20. A circumferential width of the guide groove 61g is smaller than a circumferential width of the pocket 20 by 2 x W1. That is, the guide surface 61a is positioned in advance of the wall surface of the column center part 16 opposed to the pocket 20 by a width W1. A circumferential width of the tip end part 62a of the burnishing jig 62 is the same as a width of the guide groove 61g, and the wall surface of the tip end part 62a mates with the guide surface 61a. When the burnishing jig 62 is inserted into the pocket 20 to perform the burnishing process, the guide groove 61g receives the tip end part 62a. Meanwhile, a circumferential width of a base part 62b of the burnishing jig 62 to support the tip end part 62a is larger than that of the tip end part 62a, and a wall surface 62c of the base part 62b is inclined such that its circumferential width increases with distance from the tip end part 62a. A circumferential width of the base part 62b on the side of the tip end is larger than a circumferential width of the pocket 20 by 2×W2. That is, the wall surface 62c on the tip end side is positioned at the back of the wall surface of the column center part 16 opposed to the pocket 20 by a width W2. A step difference 62d is provided between the tip end of the wall surface 62c and the wall surface of the tip end part 62a. The step difference 62d is a wall surface which is inclined steeply as compared with the wall surface 62c.

FIG. 19 is a cross-sectional view showing a state taken along A-A and taken from an arrow in FIG. 17, and schematically shows a situation after the burnishing jig 62 has been pressed in the pocket 20 by the burnishing process. The wall surface 62c of the burnishing jig 62 circumferentially pushes and expands the wall surface of the column center part 16 by W2, and pushes it to the radial inner side to form the first roller stopper part 16a (hereinafter, referred to as the burnished claw 16a occasionally) and the non-contact part 16c. The noncontact part 16c is formed so as to be inclined along the end face 62c on the radial outer side of the column center part 16c. In addition, the first roller stopper part 16a is formed so as to project by the width W1 on the radial inner side of the column center part 16c.

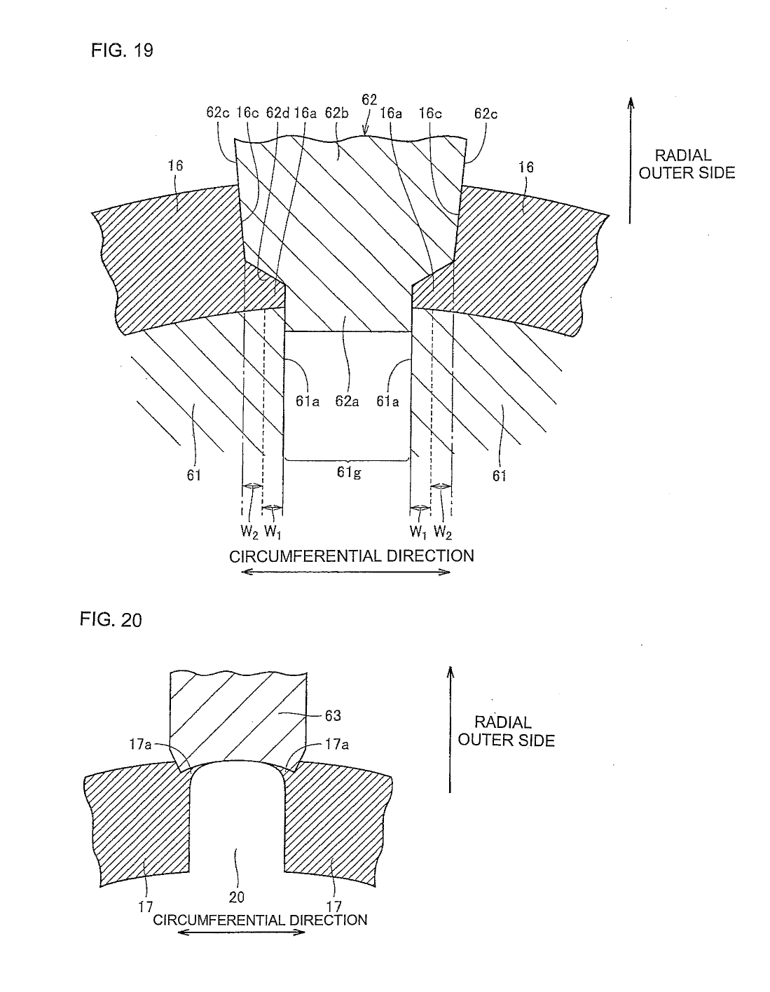

FIG. 20 is a cross-sectional view showing a state taken along B-B and taken from an arrow direction in FIG. 17, and shows a situation in which the caulking tool 63 is pressed onto the column end part 17c in the caulking process. The caulking tool 63 compresses and deforms the outer diameter surface of the column end part 17 to narrow the width of the pocket 20 on the radial outer side and form the second roller stopper part 17a (hereinafter, referred to as the caulked claw 17a occasionally).

As shown in FIGS. 16 to 20, each of the first roller stopper part 16a and the second roller stopper part 17a are formed by the process only from the radial outer side of the cylindrical member 22 which will be formed into the roller bearing cage 13. The first roller stopper part 16a and the second roller stopper part 17a may be formed separately in terms of time, but they are preferably formed at the same time by the jig 60 as shown in FIGS. 16 and 17. Thus, a time required for the process is shortened and production efficiency of the roller bearing cage 13 can be improved.

In addition, although not shown in the drawing, the first roller stopper part 16a and the second roller stopper part 17a may be formed by a process only from the radial inner side of the roller bearing cage 13. In this case, a roller stopper part on the radial inner side is the caulked claw, and a roller stopper part on the radial outer side is burnished claw.

Then, in the sixth step S16 in FIG. 6, the cage 13 is subjected to a heat treatment to provide a predetermined mechanical property such as surface hardness. As for the heat treatment, it is necessary to select an appropriate method depending on a carbon content of the starting material so that the cage 13 obtains a hardened layer having a sufficient deepness. More specifically, when the material contains 0.15% to 0.5% by weight of carbon, a carburization quenching treatment is performed, and when the material contains 0.5% to 1.1% by weight of carbon, a bright quenching treatment or a high-frequency quenching treatment is performed.

The carburization quenching treatment is a heat treatment method using the phenomenon that carbon is soluble in steel at high temperature, so that a surface layer having a large amount of carbon (carburized hard layer) can be obtained while a steel inside has a small amount of carbon.

This method realizes a property of being hard on the surface and soft and high in toughness on the inside. In addition, its facility cost is low as compared with a facility of a carbonitriding treatment.

The bright quenching treatment is a heat treatment performed by heating an object in a protected atmosphere or in a vacuum to prevent a steel surface from being oxidized. In addition, its facility cost is low as compared with those of the carbonitriding treatment and the carburization quenching treatment.

The high-frequency quenching treatment is a method to form a quenched hard layer by heating rapidly and cooling rapidly a steel surface by use of a principle of induction heating. It has a merit of being considerably low in cost of a facility as compared with other quenching treatment facilities and being good for the environment because gas is not used in a heat treatment step. In addition, it is advantageous in that a quenching treatment can be partially performed.

Furthermore, it is preferable to perform a tempering treatment after the quenching treatment in order to reduce a residual stress and internal distortion generated in the quenching treatment, and to improve the toughness and stabilize the dimension.

Thus, through the first step S11 to the sixth step S16 described above, the cage 13 shown in FIG. 1 is completed. In addition, the surface roughness of the outer diameter surface of the cage 13 has been already 0.05 μm to 0.3 μm by the ironing process when the cylindrical member 22 is formed (S11). Therefore, it is not necessary to perform a grinding process step which is separately performed as a finishing process step.

Through the above first to sixth steps S11 to S16, the cage 13 can be formed. Thus, the needle roller bearing 11 shown in FIG. 2 is completed by pressing the needle rollers 12 in the pockets 20 of the cage 13.

Meanwhile, according to this embodiment, each of the first and second roller stopper parts 16a and 17a can be formed by the process only from the one radial side, so that the jig 62 to form the first roller stopper part 16a and the jig 63 to form the second roller stopper part can be arranged on the same side with respect to the cage 13. Therefore, processing facilities of the roller stopper parts 16a and 17a can be simple. Moreover, the jig 62 to form the first roller stopper part 16a and the jig 63 to form the second roller stopper part 17a can be integrated to the jig 60 and the two kinds of roller stopper parts 16a and 17a can be formed in the same step S15. Therefore, the number of processing steps can be reduced as compared with the conventional case. In addition, since the roller stopper parts 16a and 17a are provided on the wall surfaces 16b and 17b of the column part 15 opposed to the pockets, respectively, the allowance amount of the roller can be sufficiently ensured, and the roller is prevented from escaping from the cage 13 even when the roller has a small diameter.

In addition, since the roller stopper parts 16a and 17a are formed by the burnishing process and the caulking process, respectively in the fifth step S15 in this embodiment, the roller stopper parts are sufficiently strong and superior in durability, as compared with the conventional cage having a roller stopper part formed by a machining process such as cutting as disclosed in the Japanese Unexamined Patent Publication No. 2000-18258.

In addition, since the cage 13 is formed from the cylindrical member 22 having no joint in the circumferential direction in the first step S11 in this embodiment, it is sufficiently strong and superior in durability, as compared with the cage provided such that band steel is subjected to a rolling process and bonded by welding as disclosed in the Japanese Patent No. 3665653.

In addition, according to this embodiment, as shown in FIGS. 16 and 17, since each of the first and second roller stopper parts 16a and 17a is formed by the process only from the radial outer side of the cage 13, the roller stopper part 16a positioned on the radial inner side and the roller stopper part 17a positioned on the radial outer side can be easily formed.

Furthermore, as shown in FIGS. 18 and 19, the first roller stopper part 16a is the burnished claw formed by burnishing the wall surface of the column part 15 (16) opposed to the pocket 20 with the jig 62 used for burnishing process and inserted from the radial outer side into the pocket 20. Thus, the burnished claw can prevent the roller 12 from escaping to the radial inner side.

In addition, as shown in FIG. 20, the second roller stopper part 17a is the caulked claw formed by caulking the outer diameter of the column part 15 (17) with the jig 63 used for the caulking process. Thus, the caulked claw 17a can prevent the roller 12 from escaping to the radial outer side.

Especially, according to this embodiment, the column part 15 includes the column center part 16 positioned on the relatively radial inner side in the axial center region, the pair of column end parts 17 and 17 positioned on the relatively radial outer side in the axial end regions, and the pair of column slope parts 18 and 18 positioned between the column center part 16, and the pair of column end parts 17 and 17, and the first roller stopper parts 16a are provided in the column center part 16, and the second roller stopper part 17a is positioned in each of the pair of column end parts 17 and 17. Thus, the cage 13 can be high in strength and light in weight.

In addition, the thickness t1 of the column center part 16, the pair of column end parts 17 and 17, and the pair of column slope parts 18 and 18 is smaller than the thickness t2 of the boundary part between the adjacent parts. Thus, the strength of the boundary part can be relatively high, so that the durability of the cage 13 can be improved.

The roller bearing 11 provided with the cage 13 according to this embodiment, and the plurality of rollers 12 housed in the pockets 20 is advantageous in cost because the number of processing steps of the roller stopper parts 16a and 17a is reduced as compared with the conventional case.

In producing the roller bearing cage 13 having the pair of annular ring parts 14, the plurality of column parts 15 to mutually connect the pair of ring parts 14 and 14, the pockets 20 for housing the rollers 12 between the adjacent column parts 15, and the first and second roller stopper parts formed on the wall surfaces 16b and 17b of the column part 15 opposed to the pocket 20 on the radial inner side and the radial outer side, respectively to prevent the roller from escaping, the method for producing the cage 13 according to this embodiment includes the step of forming the pair of ring parts 14 and 14, the plurality of column parts 15, and the pockets 20 in the cylindrical member 22 serving as the starting material, the step of forming the first roller stopper part 16a by processing the cylindrical member 22 only from the one radial side, and the step of forming the second roller stopper part 17a by processing the cylindrical member 22 only from the one radial side. Thus, since each of the first roller stopper part 16a positioned on the radial inner side and the second roller stopper part 17a positioned on the radial outer side is formed by the process only from the one radial side, the number of processing steps can be reduced as compared with the conventional case, and the cage 13 advantageous in cost can be produced.

Especially, as shown in FIGS. 16 and 17, since the step of forming the first roller stopper part 16a and the step of forming the second roller stopper part 17a are performed at the same time, a process time can be shortened and the cage 13 advantageous in cost can be produced.

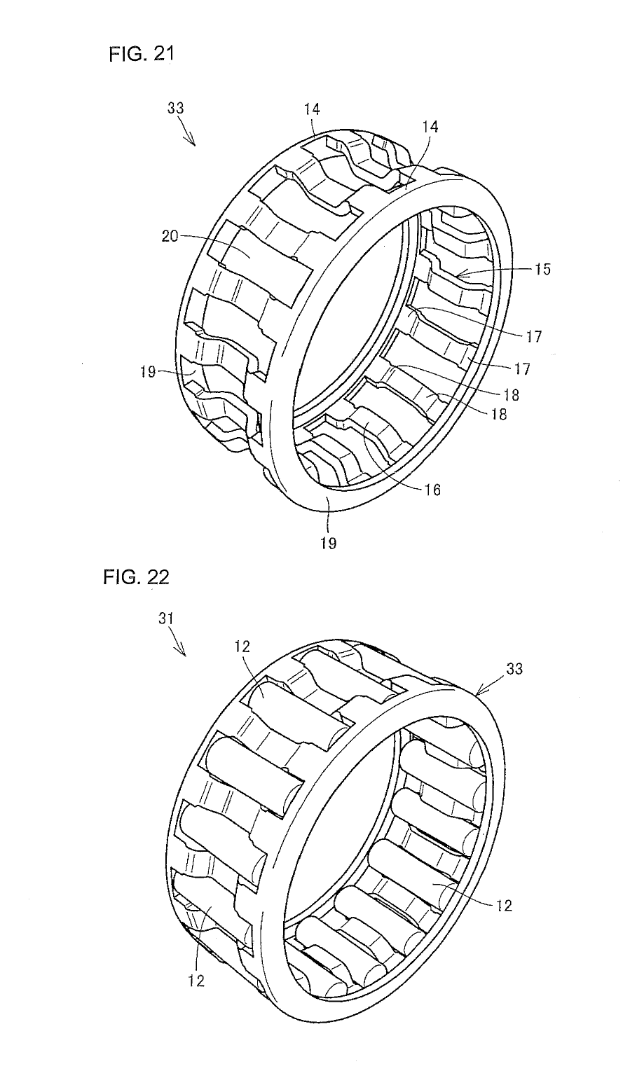

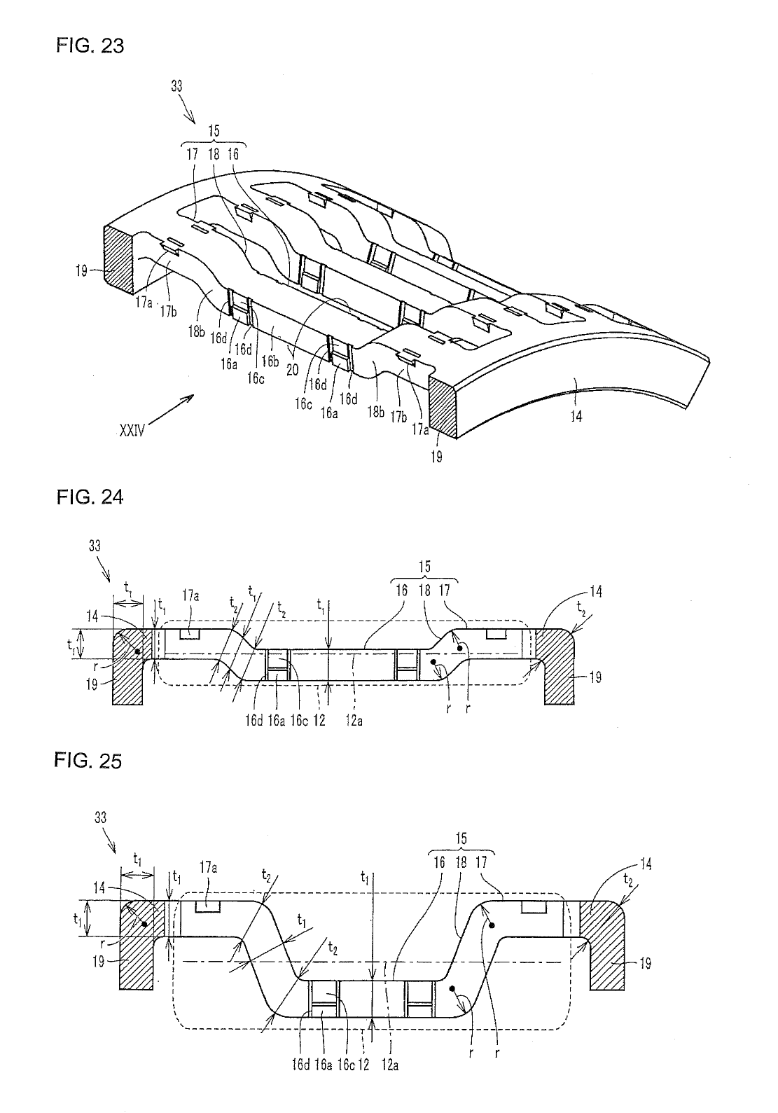

Next, with reference to FIGS. 21 to 28, a description will be made of a cage 33 and a method for producing the same according to another embodiment of the present invention. In addition, the same component has the same references as that of the cage 13 and its description is omitted.

First, referring to FIGS. 21 to 25, the cage 33 further includes a pair of flange parts 19 extending from a pair of ring parts 14 toward the radial inner side. In addition, a thickness of the ring part 14 and an axial thickness of the flange part 19 are set to be substantially equal to a thickness t1 of a linear part of a column part 15. In addition, a thickness of a boundary part between the ring part 14 and the flange part 19 is set to be substantially equal to a thickness t2 of the other boundary parts. Furthermore, a curvature radius of the boundary part between the ring part 14 and the flange part 19 is set to be substantially equal to a curvature radius r of the other boundary parts.

That is, in this embodiment also, a relationship such that t1<t2 is established. Thus, in addition to the effect described above, strength of a root part of the flange part 19 is improved. In addition, a relationship such that r<t1 is also established. Thus, since a surface area of an outer diameter surface of the ring part 14 increases, a contact surface pressure with a housing can be further reduced in the case where the cage 33 is the outer diameter side guide. In addition, since the other configuration is the same as that of the cage 13, its description is omitted.

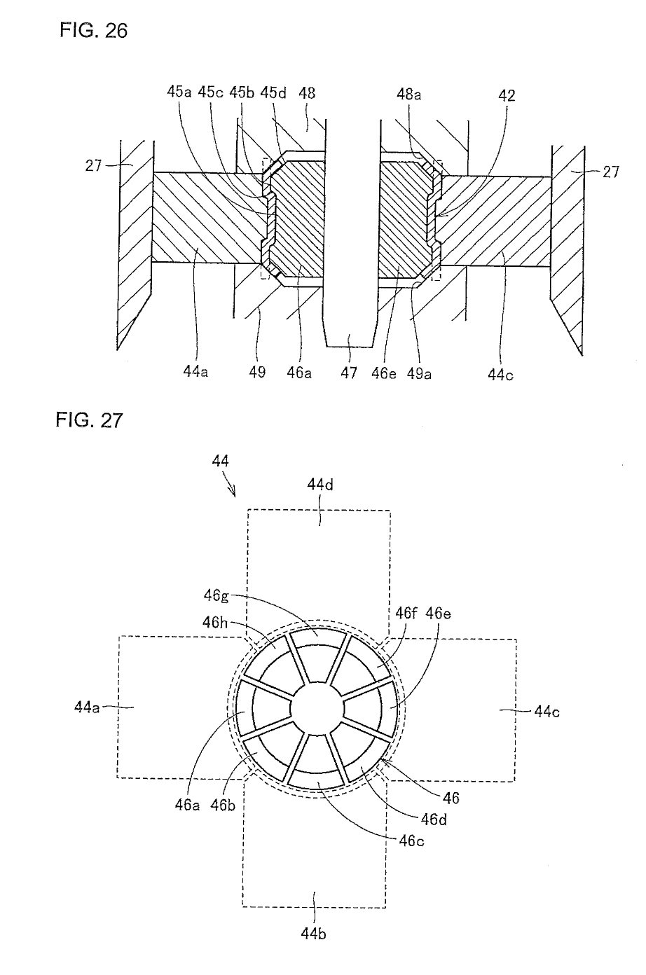

Production steps of the cage 33 having the above configuration are the same as the first step S11, the second step S12, the fourth step S14, and the fifth step S15 of the cage 13 shown in FIG. 6, so that their descriptions are omitted. A description will be made of a thickening process (corresponding to S13 in FIG. 6) and a necking process for the cage 33 with reference to FIGS. 26 to 28.

A cylindrical member 42 to be formed into the cage 33 is set between a necking outer die 44 and an inner die 46, and the thickening process of the boundary part and the formation (necking process) of the flange part 19 are performed at the same time. Here, the flange part 19 is formed through two steps composed of a preprocessing step of bending the member at a predetermined angle with respect to an axial direction, and a post-processing step of bending the member at 90° with respect to the axial direction. Thus, the thickening process of the boundary part and the post-processing step are performed at the same time.

First, referring to FIG. 26, in the preprocessing step, axial both ends which will be formed into the flange parts 19, of the cylindrical member 42 are bent inward at the predetermined angle (45° in this embodiment) with respect to a column end part 17, and this step is performed with the necking outer die 44 (hereinafter, referred to as the “outer die 44” simply), the necking inner die 46 (hereinafter, referred to as the “inner die 46” simply), and a pair of necking jigs 48 and 49.

The outer die 44 has the same configuration as that of the expansion pressing outer die 24, and holds an outer diameter surface of the cylindrical member 42. Here, it is to be noted that its axial length is smaller than that of the expansion pressing outer die 24, and it does not hold the axial both ends which will be formed into the flange parts 19, of the cylindrical member 42.

Referring to FIG. 27, the inner die 46 is composed of first to eighth split inner dies 46a, 46b, 46c, 46d, 46e, 46f, 46g, and 46h which are split at an angle of 45° in a radial fashion. Each of the first to eighth split inner dies 46a to 46h is provided so as to be able to move in a radial direction.

Referring to FIG. 26, the inner die 46 is a cylindrical member including a small diameter part 45a formed in an axial center region of an outer diameter surface so as to correspond to an inner diameter dimension of a column center part 16, a large diameter part 45b in an axial end region thereof so as to correspond to an inner diameter dimension of the column end part 17, a slope part 45c provided between the small diameter part 45a and the large diameter part 45b so as to be along a column slope part 18, and a necking part 45d formed at a corner part of each axial end so as to define the bending angle (45°) of the flange part 19 in the preprocessing step.

More specifically, when the first to eight split inner dies 46a to 46h are moved backward to the radial inner side, the first to eighth split inner dies 46a to 46h can be taken in and out of the cylindrical member 42. Meanwhile, when the first to eighth split inner dies 46a to 46h are moved forward, they can hold the inner diameter surface of the cylindrical member 42 (a state shown in FIG. 26). In addition, the split inner dies 46a to 46h can be moved forward by inserting an inserting jig 47.

The necking jig 48 has a tip end serving as a necking part 48a provided along the inclined angle (45°) of the flange part 19 in the preprocessing step, and can be moved in the axial direction of the cylindrical member 42. The necking jig 49 also has the same configuration. Thus, when the pair of necking jigs 48 and 49 is axially moved backward, the cylindrical member 42 can be taken in and out of a cylindrical space. Meanwhile, when the pair of necking jigs 48 and 49 is axially moved forward, it can bend both axial ends (shown by broken lines in FIG. 26) of the cylindrical member 42 toward the inner side at the predetermined angle (45°).

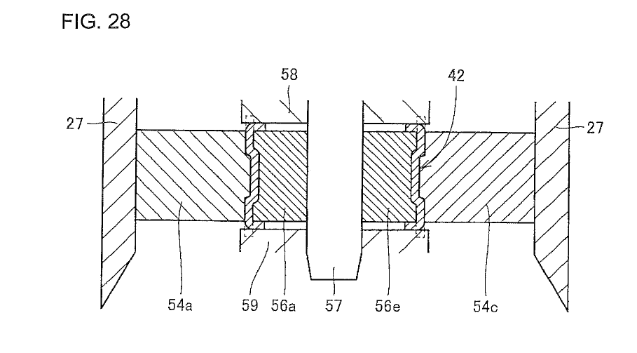

Then, referring to FIG. 28, the flange part 19 is bent inward at an angle of 90° with respect to the column end part 17 in the post-processing step. Processing jigs in the post-processing step include necking outer dies 54a to 54d (only 54a and 54c are shown), necking inner dies 56a to 56h (only 56a and 56e are shown), an inserting jig 57, and a pair necking jigs 58 and 59 which have almost the same configuration as those used in the preprocessing step. In addition, the outer die 44 and the outer die 54 may be the same die and may be shared in the preprocessing step and the post-processing step. The same thing is applied to the inserting jig 47 and the inserting jig 57.

In the post-processing step, the inner and outer diameter surfaces of the cylindrical member 42 are held by the same procedure as that of the pre-processing step, and the flange part 19 is axially compressed by the necking jigs 58 and 59. Thus, the angle between the column end part 17 and the flange part 19 becomes 90°. In addition, in this step, the boundary part can be thickened similarly to the third step S13 shown in FIG. 6.

In this case, the cage 33 according to this embodiment further includes the flange parts 19 extending from the pair of ring parts 14 and 14 to the radial inner side, and the thickness t1 of the pair of ring parts 14 and 14, and the flange part 19 is smaller than the thickness t2 of the boundary part between the ring part 14 and the flange part 19. Thus, the strength of the boundary part can be relatively high, and the durability of the cage 33 can be improved.

In addition, while the cages 13 and 33 are produced using the flat steel plate as the starting material in the above embodiments, the present invention is not limited to this, and a cylindrical member composed of a pipe material may be used as the starting material. In this case, the first step S11 in FIG. 6 can be omitted.

While the cage & roller type needle roller bearings 11 and 31 are shown in the description, the present invention can be applied to a needle roller bearing further including at least one of an inner ring and an outer ring. In addition, while the needle roller 12 is used as a rolling body, a cylindrical roller or a rod-shaped roller may be used.

Furthermore, when the needle roller bearings 11 and 31 according to the above embodiments are used as an idler bearing of a car transmission, a planet gear of a car transmission, and a con rod large end bearing of a motorbike engine, especially advantageous effect can be provided.

While the embodiments of the present invention have been described with reference to the drawings in the above, the present invention is not limited to the above-illustrated embodiments. Various kinds of modifications and variations may be added to the illustrated embodiments within the same or equal scope of the present invention.

### INDUSTRIAL APPLICABILITY

The present invention can be advantageously applied to a roller bearing cage, and a needle roller bearing.

### EXPLANATION OF REFERENCES

11, 31 NEEDLE ROLLER BEARING, 12 NEEDLE ROLLER, 12A PITCH CIRCLE, 13, 33 CAGE, 14 RING PART, 15 COLUMN PART, 16 COLUMN CENTER PART, 17 COLUMN END PART, 18 COLUMN SLOPE PART, 16A FIRST ROLLER STOPPER PART (BURNISHED CLAW), 17A

SECOND ROLLER STOPPER PART (CAULKED CLAW), 16B, 17B, 18B WALL SURFACE, 16C NON-CONTACT PART, 16D OIL GROOVE, 19 FLANGE PART, 20 POCKET, 21 CUP-SHAPED MEMBER, 21A BOTTOM WALL, 21B OUTWARD FLANGE PART, 21C INWARD FLANGE PART, 22, 42 CYLINDRICAL MEMBER, 24, 44 OUTER DIE, 23A CYLINDRICAL SPACE, 23B, 25A, 26A, 45A SMALL DIAMETER PART, 23C, 25B, 26B, 45B LARGE DIAMETER PART, 23D, 25C, 26C, 45C SLOPE PART, 24A, 24B, 24C, 24D, 44A, 44B, 44C, 44D, 54A, 54C SPLIT OUTER DIE, 25, 26, 46 INNER DIE, 46A, 46B, 46C, 46D, 46E, 46F, 46G, 46H, 56A, 56E SPLIT INNER DIE, 27 MOVING JIG, 28, 29 COMPRESSING JIG, 47, 57 INSERTING JIG, 48, 49, 58, 59 NECKING JIG, 45D, 48A, 49A NECKING PART, 60 JIG, 61 PROCESS TABLE, 61G GUIDE GROOVE, 62 BURNISHING JIG, 63 CAULKING JIG, 65 PROCESS TABLE

1. A roller bearing cage comprising a pair of annular ring parts, and a plurality of column parts to mutually connect said pair of ring parts, and having pockets to house rollers between said adjacent column parts, wherein
said column part includes a first roller stopper part arranged on the radial inner side to prevent the roller from escaping to the radial inner side, and a second roller stopper part arranged in the radial outer side to prevent the roller from escaping to the radial outer side, on wall surfaces opposed to said pocket, and each of said first and second roller stopper parts is formed by a process only from one radial side.

2. The roller bearing cage according to claim 1, wherein each of said first and second roller stopper parts is formed by a process only from a radial outer side of the roller bearing cage.

3. The roller bearing cage according to claim 2, wherein said first roller stopper part is a burnished claw formed by burnishing the wall surface of said column part opposed to said pocket with a processing jig inserted from the radial outer side to said pocket.

4. The roller bearing cage according to claim 2, wherein the second roller stopper part is a caulked claw formed by caulking an outer diameter surface of said column part with a processing jig.

5. The roller bearing cage according to claim 1, wherein
said column part includes a column center part positioned on the relatively radial inner side in an axial center region, a pair of column end parts positioned on the relatively radial outer side in axial end regions, and a pair of column slope parts positioned between said column center part, and said pair of column end parts, respectively, and
said first roller stopper part is provided in the column center part, and said second roller stopper part is provided in each of said pair of column end parts.

6. The roller bearing cage according to claim 5, wherein
a thickness of each part of said column center part, said pair of column end parts, and said pair of column slope parts is smaller than a thickness of a boundary part adjacent to each part.

7. The roller bearing cage according to claim 1, further comprises a flange part extending from each of said pair of ring parts toward the radial inner side, wherein
a thickness of said pair of ring parts, and said flange part is smaller than a thickness of a boundary part between said ring part and said flange part.

8. A roller bearing comprising;
the roller bearing cage according to claim 1; and
a plurality of rollers housed in said pockets.

9. A method for producing a roller bearing cage comprising a pair of annular ring parts, a plurality of column parts to mutually connect said pair of ring parts, pockets to house rollers between said adjacent column parts, and first and second roller stopper parts provided on the radial inner side and the radial outer side, respectively, on wall surfaces of said column opposed to said pocket, to prevent the roller from escaping, comprising;
a step of forming said pair of ring parts, said plurality of column parts, and said pockets in a cylindrical member serving as a starting material;
a step of forming said first roller stopper part by processing said cylindrical member only from one radial side; and
a step of forming said second roller stopper part by processing said cylindrical member only from the one radial side.

10. The method for producing the roller bearing cage according to claim 9, wherein
said step of forming the first roller stopper part and said step of forming the second roller stopper part are performed at the same time.
